(19) United States
(12) Patent Application Publication
(10) Pub. No.: US 2014/0050113 A1
(43) Pub. Date: Feb. 20, 2014

(54) Method and Apparatus for Deactivating One of a Primary and Secondary Cells of a User Equipment

(71) Applicants: Claudio Rosa, Randers (DK); Frank Frederiksen, Klarup (DK); Benoist Pierre Sebire, Tokyo (JP)

(72) Inventors: Claudio Rosa, Randers (DK); Frank Frederiksen, Klarup (DK); Benoist Pierre Sebire, Tokyo (JP)

(73) Assignee: Nokia Siemens Networks Oy, Espoo (FI)

(21) Appl. No.: 14/113,677

(22) PCT Filed: Apr. 29, 2011
(86) PCT No.: PCT/EP11/56856

§ 371 Date: Oct. 24, 2013

(51) Int. Cl. H04W 16/24; H04W 72/12

(52) U.S. Cl. CPC H04W 16/24; H04W 72/12
USPC 370/252; 370/328; 370/329

(57) ABSTRACT

A method includes causing a primary cell for a user equipment to be deactivated. The said user equipment has at least one active secondary cell.

The invention relates to a method and apparatus and in particular but not exclusively to a method and apparatus for use in a system with carrier aggregation.

A communication system enables communication between two or more communication devices such as user terminals, base stations and/or other nodes by providing carriers between the communication devices. In a wireless communication system at least a part of communications between at least two stations occurs over wireless interfaces. A user can access a communication system by means of an appropriate communication device or terminal. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

Carrier aggregation can be used to increase performance. In carrier aggregation a plurality of carriers are aggregated to increase bandwidth. Carrier aggregation comprises aggregating a plurality of component carriers into a carrier that is referred to in this specification as an aggregated carrier.

According to an embodiment, there is provided a method comprising: causing a primary cell for a user equipment to be deactivated, said user equipment having at least one active secondary cell.

The method may comprise deactivating at least part of a radio frequency branch of said user equipment associated with said primary cell.

The method may comprise radio link monitoring of said deactivated primary cell less frequently than when the primary cell is activated.

The method may comprise causing feedback information to be conveyed via said secondary cell.

The feedback information may comprise at least one of channel quality information, scheduling request and hybrid automatic repeat request acknowledgement/non acknowledgement.

The method may comprise using allocated physical uplink shared channel on said secondary cell to convey said feedback information.

The method may comprise causing information to be provided to a base station indicating that data for transmission is in a buffer of said user equipment.

The method may comprise using physical uplink control channel resources on said secondary cells.

The method may comprise using one of said active secondary cells to schedule traffic on at least one other active secondary cell when said primary cell is deactivated.

The at least one other secondary cell may have a lower control channel overhead as compared to said scheduling secondary cell.

The scheduling secondary cell may be the secondary cell with a lowest index.

The scheduling secondary cell may be indicated via signaling.

The scheduling secondary cell may have a first identity which is used when said primary cell is active and a second identity which is used when said primary cell is deactivated

The method may comprise determining that the primary cell is to be deactivated and only deactivating said primary cell if at least one secondary cell is activated.

The method may comprise determining that a primary cell is to be deactivated and activating a secondary cell if said primary cell is the only active cell for a user equipment.

The method may comprise, comprising determining if a secondary cell is to be deactivated and reactivating said primary cell.

The method may comprise reactivating said primary cell if the secondary cell to be deactivated is the only active cell.

The method may comprise deactivating said primary cell responsive to control information received from a base station.

The method may comprise deactivating said primary cell responsive to expiry of a timer.

The method may comprise causing a user equipment to be configured with an uplink and a downlink for said primary cell and for said at least one active secondary cell.

The method may comprise causing a user equipment to be configured with an uplink and a downlink for said primary cell and only a downlink for at least one active secondary cell.

The method may comprise, responsive to deactivation of said primary cell, causing an uplink to be configured for said at least one active secondary cell.

According to another embodiment, there is provided a computer program comprising at least one computer executable instruction which when run on a processor is configured to cause the any of the above method to be performed.

According to another embodiment, there is provided an apparatus comprising at least one processor and at least one memory including computer program code, the at least one memory and computer program code configured, with the at least one processor, to cause the apparatus to: cause a primary cell for a user equipment to be deactivated, said user equipment having at least one active secondary cell.

The at least one memory and computer program code may be configured, with the at least one processor, to cause the apparatus to deactivate at least part of a radio frequency branch of said user equipment associated with said primary cell.

The at least one memory and computer program code may be configured, with the at least one processor, to cause the apparatus to perform radio link monitoring of said deactivated primary cell less frequently than when the primary cell is activated.

The at least one memory and computer program code may be configured, with the at least one processor, to cause the apparatus to cause feedback information to be conveyed via said secondary cell.

The feedback information may comprise at least one of channel quality information, scheduling request and hybrid automatic repeat request acknowledgement/non acknowledgement.

The at least one memory and computer program code may be configured, with the at least one processor, to cause the apparatus to use allocated physical uplink shared channel on said secondary cell to convey said feedback information.

The at least one memory and computer program code may be configured, with the at least one processor, to cause the apparatus to cause information to be provided to a base station indicating that data for transmission is in a buffer of said user equipment.

The at least one memory and computer program code may be configured, with the at least one processor, to cause the apparatus to use physical uplink control channel resources on said secondary cells.

The at least one memory and computer program code may be configured, with the at least one processor, to cause the apparatus to use one of said active secondary cells to schedule traffic on at least one other active secondary cell when said primary cell is deactivated.

The at least one other secondary cell may have a lower control channel overhead as compared to said scheduling secondary cell.

The scheduling secondary cell may be the secondary cell with a lowest index.

The scheduling secondary cell may be indicated via signaling.

The scheduling secondary cell may have a first identity which is used when said primary cell is active and a second identity which is used when said primary cell is deactivated

The at least one memory and computer program code may be configured, with the at least one processor, to cause the apparatus to determine that the primary cell is to be deactivated and only deactivating said primary cell if at least one secondary cell is activated.

The at least one memory and computer program code may be configured, with the at least one processor, to cause the apparatus to, determine that a primary cell is to be deactivated and activate a secondary cell if said primary cell is the only active cell for a user equipment.

The at least one memory and computer program code may be configured, with the at least one processor, to cause the apparatus to determine if a secondary cell is to be deactivated and if so, reactivating said primary cell.

The at least one memory and computer program code may be configured, with the at least one processor, to cause the apparatus to reactivate said primary cell if the secondary cell to be deactivated is the only active cell.

According to another embodiment, there is provided an apparatus comprising means for causing a primary cell for a user equipment to be deactivated, said user equipment having at least one active secondary cell.

User equipment and/or a base station may comprise any of the apparatus described above.

Embodiments will now be described in further detail, by way of example only, with reference to the following examples and accompanying drawings, in which:

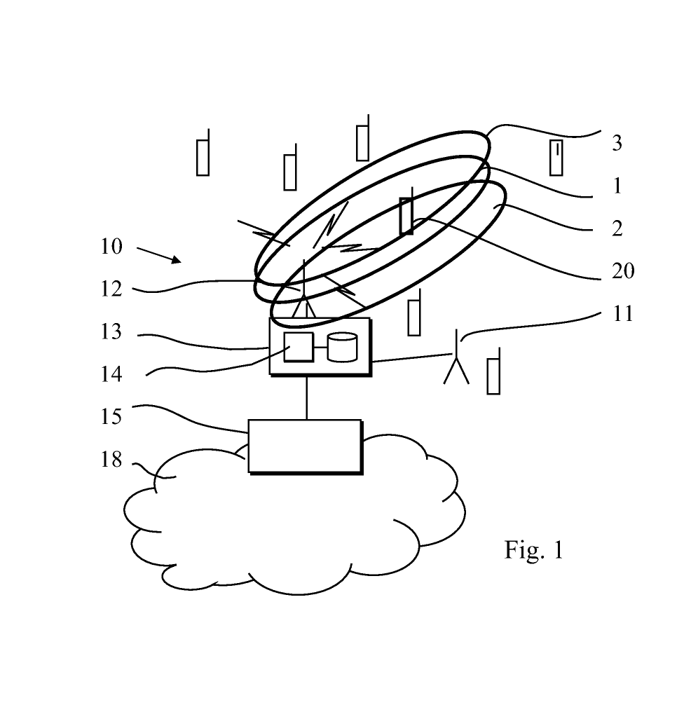

FIG. 1 shows an example of a system wherein below described embodiments may be implemented;

FIG. 2 shows an example of a communication device

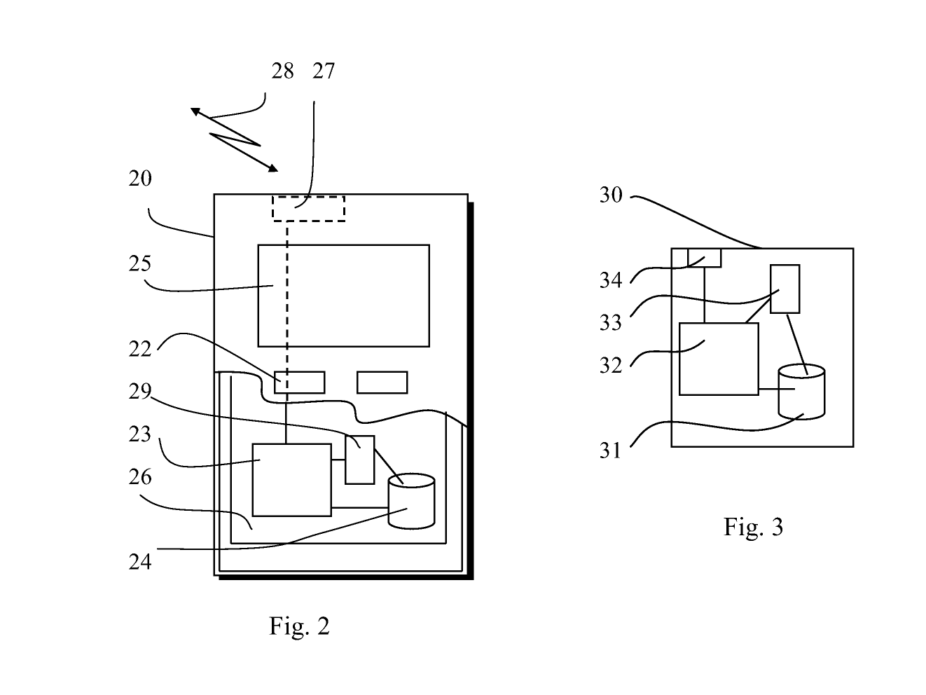

FIG. 3 shows an example of a control apparatus;

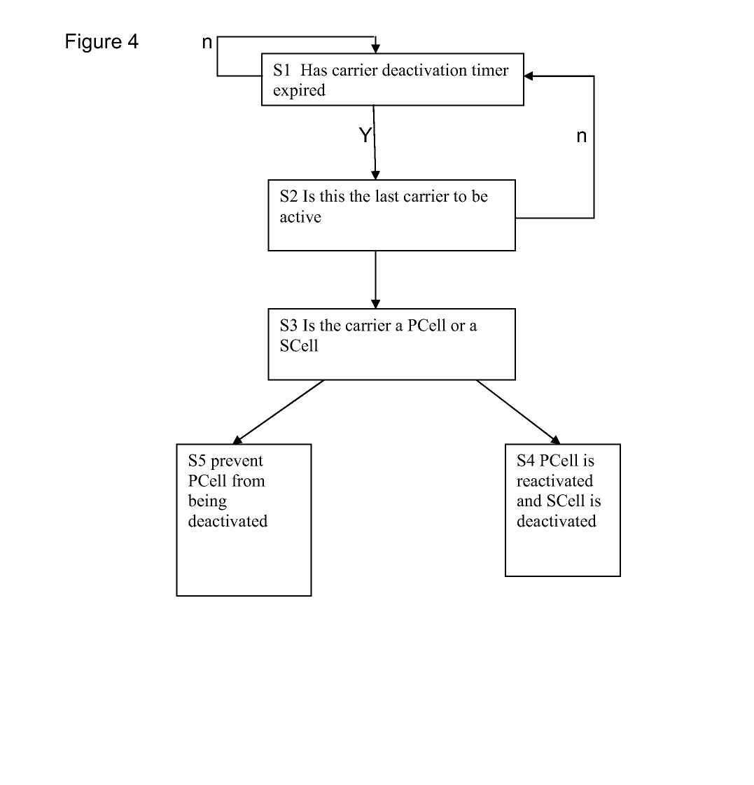

FIG. 4 shows a method embodiment in which it is determined if a PCell is permitted to be deactivated;

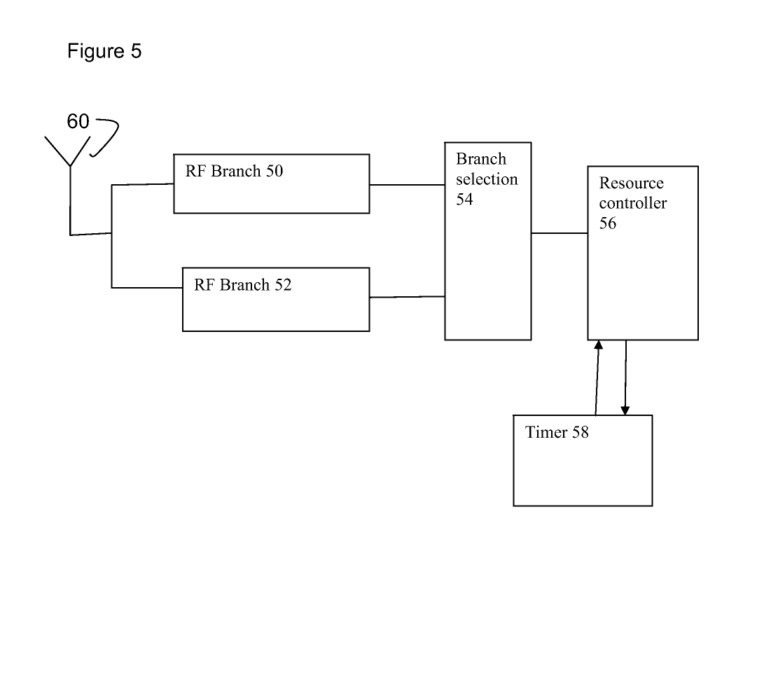

FIG. 5 schematically shows part of a user equipment;

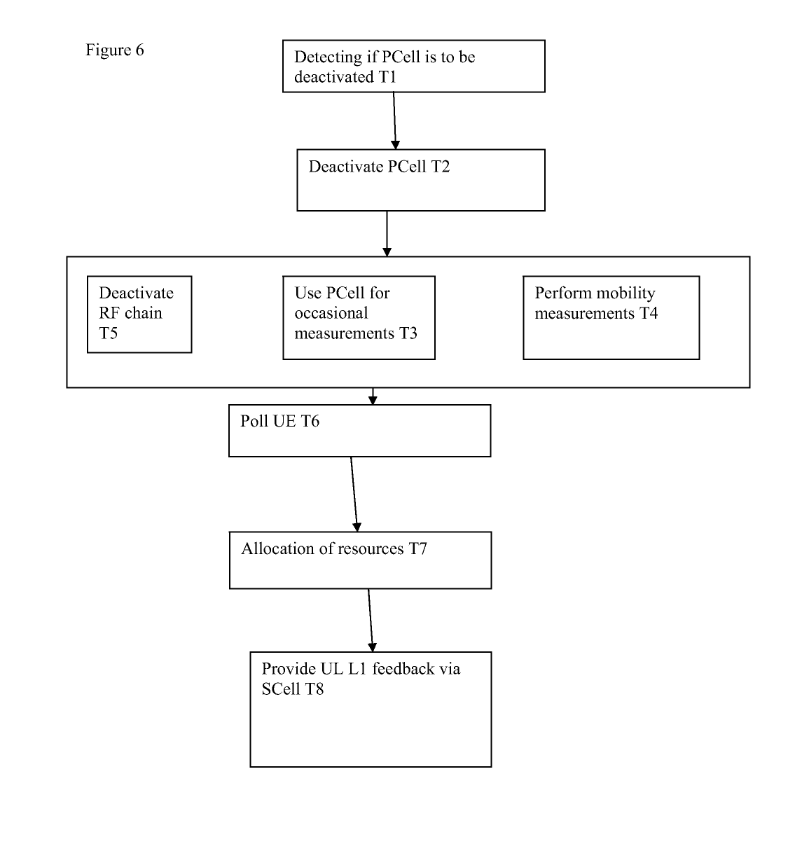

FIG. 6 shows another method where there is deactivation of a PCell; and

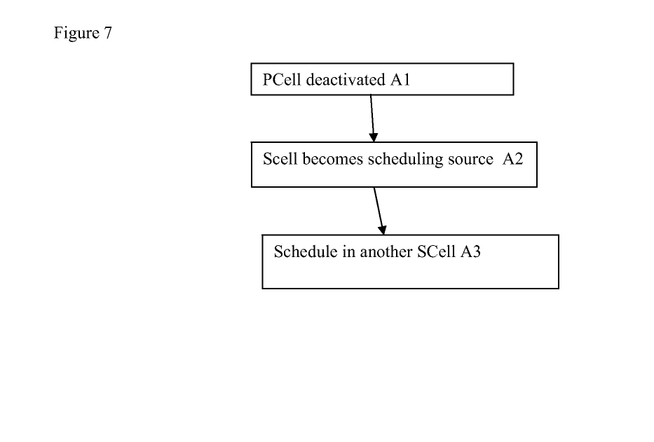

FIG. 7 shows another method with cross scheduling between cells.

In the following certain exemplifying embodiments are explained with reference to a wireless communication system serving devices adapted for wireless communication. Therefore, before explaining in detail the exemplifying embodiments, certain general principles of a wireless system, components thereof, and devices for wireless communication are briefly explained with reference to system 10 of FIG. 1, device 20 of FIG. 2 and control apparatus 30 of FIG. 3 to assist in understanding the technology underlying the described examples.

A communication device can be used for accessing various services and/or applications provided via a communication system. In wireless or mobile communication systems the access is provided via a wireless access interface between mobile communication devices and an appropriate access system. A mobile device may access wirelessly a communication system via a base station. Abase station site can provide one or more cells of a cellular system. A base station can provide, for example, three carriers, each carrier providing a cell. In FIG. 1, for example, a base station 12 is shown to provide three cells 1, 2 and 3. Each cell provides a carrier F1, F2 and F3, respectively. Each mobile device 20 and base station may have one or more radio channels open at the same time and may receive signals from more than one source.

It should be appreciated that the number of carriers provided by each base station may be more or less than three and/or may vary over time.

It is noted that at least one of the cells 1 to 3 can be provided by means of remote radio heads of base station 12. Also, at least one of the carriers may be provided by a station that is not co-located at base station 12 but may only be controlled by the same control apparatus as the other cells. This possibility is denoted by station 11 in FIG. 1. For example, block 13 could be used to control at least one further station, for example an intra-eNB. Interaction between the different stations and/or controllers thereof may also be arranged otherwise, for example if a station is provided as an inter-site eNB. For the purposes of understanding this disclosure it is sufficient to assume that a controller of a cell has enough information for all of the aggregated carriers (cells).

A base station is typically controlled by at least one appropriate controller so as to enable operation thereof and management of mobile communication devices in communication with the base station. The control entity can be interconnected with other control entities. The control entity may be part of the base station. In FIG. 1 the controller is shown to be provided by block 13. The controller apparatus may comprise at least one memory, at least one data processing unit and an input/output interface. It shall be understood that the control functions may be distributed between a plurality of control units. The controller apparatus for a base station may be configured to execute an appropriate software code to provide the control functions as explained below in more detail.

In the FIG. 1 the base station 12 is connected to a data network 18 via an appropriate gateway 15. A gateway function between the access system and another network such as a packet data network may be provided by means of any appropriate gateway node, for example a packet data gateway and/or an access gateway. A communication system may thus be provided by one or more interconnect networks and the elements thereof, and one or more gateway nodes may be provided for interconnecting various networks.

An example of a standardized architecture is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. A development of the LTE is often referred to as LTE-Advanced (LTE-A).

A communication device can access a communication system based on various access techniques, such as code division multiple access (CDMA), or wideband CDMA (WCDMA). The latter technique is used by communication systems based on the third Generation Partnership Project (3GPP) specifications. Other examples include time division multiple access (TDMA), frequency division multiple access (FDMA), space division multiple access (SDMA) and so on. A non-limiting example of mobile architectures where the herein described principles may be applied is known as the Evolved Universal Terrestrial Radio Access Network (E-UTRAN). In LTE, an orthogonal frequency division multiple (OFDMA) access technique is used.

A non-limiting example of a base station of a cellular system is what is termed as a NodeB or evolved NodeB (eNB) in the vocabulary of the 3GPP specifications.

FIG. 2 shows a schematic, partially sectioned view of a communication device 20 that a user can use for communications. Such a communication device is often referred to as user equipment (UE) or terminal. The device may be mobile or have a generally fixed location. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia, positioning data, other data, and so on. Users may thus be offered and provided numerous services via their communication devices. Non-limiting examples of these services include two-way or multi-way calls, data communication or multimedia services or simply an access to a data communications network system, such as the Internet.

A mobile device is typically provided with at least one data processing entity 23, at least one memory 24 and other possible components 29 for use in software and hardware aided execution of tasks it is designed to perform, including control of access to and communications with base stations and other communication devices. The data processing, storage and other relevant control apparatus can be provided on an appropriate circuit board and/or in chipsets. This feature is denoted by reference 26.

The user may control the operation of the mobile device by means of a suitable user interface such as key pad 22, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

The device 20 may receive and transmit signals 28 via appropriate apparatus for receiving and transmitting signals. In FIG. 2 transceiver apparatus is designated schematically by block 27. The transceiver apparatus is provided with radio capability. The transceiver may be provided for example by means of a radio part and associated antenna arrangement. The antenna arrangement may be arranged internally or externally to the mobile device.

FIG. 3 shows an example of a control apparatus 30 for an access node, for example to be coupled to and/or for controlling a station of a radio service area, for example one of the nodes 11 or 12 of FIG. 1. The control apparatus may in some embodiments be part of the base station itself. The control apparatus 30 can be arranged to provide control on configurations, measurements, information processing and/or communication operations of an access node. A control apparatus in accordance with FIG. 3 can be configured to provide control functions in association with generation, communication and interpretation of information regarding carrier aggregation and/or other operations, such as determining cognitive radio capabilities. For providing the desired operation, the control apparatus 30 comprises at least one memory 31, at least one data processing unit 32, 33 and an input/output interface 34. Via the interface the control apparatus can be coupled to the relevant node. The control apparatus 30 can be configured to execute an appropriate software code to provide the control functions.

A feature of LTE-Advanced is that it is capable of providing carrier aggregation. For example, Release 10 (Rel-10) of the E-UTRA specifications introduces Carrier Aggregation (CA), where two or more component carriers (CCs) are aggregated in order to support wider transmission bandwidths up to 100 MHz. In CA it is possible to configure a UE to aggregate a different number of CCs originating from the same eNodeB (eNB) and of possibly different bandwidths in the uplink (UL) and/or downlink (DL). In some embodiments, when CA is configured, the UE may only have one RRC connection with the network. At RRC connection establishment/re-establishment/handover, one serving cell provides the NAS mobility information (e.g. TAI-transmit additional information), and at RRC (radio resource control) connection re-establishment/handover, one serving cell provides the security input. This cell is referred to as the Primary Cell (PCell). In the downlink, the carrier corresponding to the PCell is the Downlink Primary Component Carrier (DL PCC) while in the uplink it is the Uplink Primary Component Carrier (UL PCC).

Depending on UE capabilities, Secondary Cells (SCells) may be configured to form together with the PCell a set of serving cells. In the downlink, the carrier corresponding to a SCell is a Downlink Secondary Component Carrier (DL SCC) while in the uplink it is an Uplink Secondary Component Carrier (UL SCC).

The configured set of serving cells for a UE therefore may consist of one PCell and one or more SCells. For each SCell the usage of uplink resources by the UE in addition to the downlink ones is configurable (the number of DL SCCs configured may be larger than or equal to the number of UL SCCs and no SCell may be configured for usage of uplink resources only). From a UE viewpoint, each uplink resource may only belong to one serving cell. The number of serving cells that can be configured may depend on the aggregation capability of the UE. The PCell may only be changed with a handover procedure (i.e. with security key change and RACH procedure). The PCell may be used for transmission of PUCCH. Re-establishment may be triggered when PCell experiences RLF (radio link failure), and not when SCells experience RLF. NAS information may be taken from PCell. The reconfiguration, addition and removal of SCells may be performed by RRC.

In addition to carrier aggregation, Rel-10 introduces the possibility to de-activate SCells in order to reduce the UE power consumption. RF circuitry and potential higher sampling rates for higher bandwidths will increase power consumption.

The UE monitoring activity of a de-activated SCell is reduced as no PDCCH (physical downlink control channel) monitoring nor are CQI (channel quality indicator) measurements required. The UL activity in a de-activated SCell is also stopped (no SRS sounding reference signal is required). However, Rel-10 only supports deactivation of SCells and the UE-specific PCell is always assumed to be activated.

In Rel-10 CA has been standardized with the aim of meeting the IMT (international mobile telecommunications)-advanced data rate requirements. However, one of the main drivers to standardize CA (and inter-band CA) is flexible spectrum utilization. Flexible spectrum utilization means that CA may provide the possibility of performing fast and seamless traffic steering between different LTE frequency layers. This may use inter-band CA in different bands and/or different bandwidth combinations. An advantage of performing traffic steering with CA is that the eNB can re-direct data to/from a specific UE via one of the available CCs (and not necessarily the PCell carrier) by a simple scheduling decision (optionally preceded by activation of the corresponding CC) with no need to perform an inter-frequency handover (HO).

The inventors have noted that the current proposals specify that the PCell cannot be de-activated, which in practice means that if data to/from the UE is conveyed using the SCell the UE will still need to keep the PCell activated (e.g. for the transmission of necessary UL/DL HARQ hybrid automatic repeat request feedback). If data is conveyed via the PCell, the SCell can be temporarily de-activated, but not vice-versa.

With the current proposals, when needing to steer the data traffic to/from a UE via its SCell an operator is left with two choices: activate and schedule the SCell while the PCell remains activated, or re-configure the SCell to be the PCell (which corresponds to an intra-site HO handover). Because the intra-site handover may increase latency and delays, this may mean that fast and seamless traffic steering may come at the cost of increased UE power consumption. If both a PCell and a SCell are activated, this may require a UE to have a RF chain activated for each of the PCell and SCell.

During standardization of Rel-10 it was proposed to introduce the possibility to switch or interchange the PCell and SCell. The option may result in misalignment between what UE and eNB think is the PCell. This may impact the correct functioning of the control channels potentially for all the users served by the corresponding eNB (and not only the one swopping the PCell and the SCell). This proposal was not accepted in Rel-10.

In some embodiments, a UE is permitted to de-activate the PCell thus enabling significant UE power reduction in case of fast traffic steering between LTE carriers in different frequency bands. When PCell is de-activated for that UE, the UE does not listen to PDCCH of the PCell nor perform CQI-type of measurements on the PCell. Some embodiments will now be described with reference to FIG. 6 which shows a method.

In step T1, a determination is made that a PCell is to be deactivated for a UE. (Other UEs may still use the PCell). This determination may be made in a eNB and/or the UE. Where the determination is made by the eNB, this information may be provided to the UE.

In step T2, the PCell is deactivated for the UE. This deactivation is carried out by the UE.

When the PCell is de-activated, the UE can still use the PCell for radio link monitoring by performing occasional measurements and applying similar rules as those standardized in Rel-10 for de-activated SCells as referenced T3 When the PCell is deactivated, this means that the UE does not need to monitor the PDCCH for every subframe. In contrast when the PCell is activated for a UE, the UE will listen to the PDCCH as often as required by DRX and in the worst case for every subframe.

Additionally or alternatively when the PCell is deactivated, the UE does not need to perform CQI measurements. The UE may need only to perform mobility measurements (referenced T4), which typically have looser requirements leading to less power consumption. The UE may in some embodiments at least partially deactivate a RF chain associated with the PCell as referenced T5. It should be appreciated that the steps T3-4 will be performed after the deactivation of the PCell and in order and/or one or more of the steps may be performed at the same time.

One or more steps may take place at the same time or after any of steps T6 to T7 described below.

When the PCell is de-activated, the UE is prevented from using PUCCH resources on the PCell.

In one embodiment, the eNB scheduler has the responsibility to ensure that the UE is allocated the needed PUSCH (physical uplink shared channel) resources so that UL control information can be provided on the PUSCH via the SCell. This UL control information is UL L1 feedback information. This would be instead of the using the PUCCH of the PCell. In step T6, the eNB scheduler will periodically poll the UE for BSR (buffer status report) and scheduled CQI. The polling is done by the scheduler of the eNB. That means the scheduler allocates resources on UL SCell as referenced step T7. This allocation is done via the PDCCH transmitted on DL PCell or on DL SCell. These allocated resources can be used by the UE to transmit CQI and/or BSR to indicate for example that new data has arrived in the UE buffer as referenced T8.

The UL L1 (layer 1) feedback information (CQI, SR scheduling request and/or HARQ A/N (ACK/NACK) may be provided via the SCell. The feedback information may alternatively or additionally include any other information. Alternatively or additionally other information may be provided via the SCell. That other information may be information which is usually provided via the PCell.

It should be appreciated that steps T1 and T2 may take place in the eNB and/or the UE. Steps T3-T5 and T8 may take place in the UE. The polling may be initiated by the eNB and the UE may send responses thereto. The allocation of resources may take place in the eNB and/or the UE.

One or more of the steps may be performed under the control of one or more processors in association with one or more memories. The steps may be the result of one or more computer instructions being executed by one or more processors.

Alternatively or additionally, the DCI (downlink control information) formats may be modified and provide the possibility of scheduling HARQ A/N resources in a similar way to the scheduled CQI. By way of example, in Rel-8/9/10 there is a DCI format which is used to schedule CQI via the PDCCH. In some embodiments a DCI format is provided to schedule HARQ A/N resources when the PCell is deactivated. The mapping of these HARQ A/N resources could be derived from a number of parameters such as, but not limited to: Position in the search space, preconfigured offsets when SCell is used, various states of the downlink DCI are reserved for implicit or explicit assignment of specific UL resources for the control signalling.

Alternatively or additionally, in some embodiments, there is the option of multiplexing more than one UE per PRB (physical resource block) when scheduling A/N resources.

Alternatively or additionally in some embodiments, with a de-activated PCell there will be no UL PCell resource and one option may be to configure PUCCH resources (via RRC radio resource control signalling) on the SCell as well. This may additionally or alternatively be part of step T7. These SCell backup resources would then become active in case the PCell is de-activated for a period of time. When a PCell is activated, Rel-10 PUCCH resources are only scheduled on the UL PCell. Some embodiments may permit PUCCH resources to be scheduled on a UL SCell.

Alternatively or additionally, there is an implicit mapping between the position of a DL allocation and PUCCH index, via PUCCH resources on SCell. The PUCCH resources (PUCCH index) used for transmitting HARQ A/N on an UL PCell are derived by the UE from the corresponding PDCCH allocation (index of the used control channel elements CCE). This would require the eNB to configure a set of backup PUCCH resources corresponding to a CC used as SCell. However, overbooking may be reduced e.g. by allowing more control channel elements (CCE) to map to the same PUCCH index. In some embodiments this is used at least for the A/N resources, but could also potentially be used for the UL transmission of CSI and/or CQI information.

Alternatively or additionally, the DCI downlink control information format is arranged so that an eNB can schedule DL resources and corresponding UL resources for the transmission of A/N and/or other L1 feedback information with a single DL allocation. A small-scale pointer-indication may be provided in one embodiment with 2-4 bits for either (1) single UL PRB allocation, or (2) ‘channel selection’ within a predefined UL resource (for example for UL A/N only). This DCI format may be applicable only when PCell is de-activated.

It should be appreciated that any one or more of the different options discussed above may be used in combination or alone.

By way of example only, in one embodiment, an eNB reserves SR scheduling resources on both PCell and SCell. The SR of the SCell will be used in case of deactivation of the PCell.

Alternatively or additionally, periodic CQI resources are only allocated on PCell. In case of PCell de-activation, the eNB relies on scheduled CQI on SCell.

Alternatively or additionally, A/N resources on SCell are allocated an implicit mapping.

Alternatively or additionally the PCell may be put in to a sleep state or made inactive for a given period of time (corresponding to DRX (discontinuous reception operation)—only for the PCell). And during this period of time, one of the options described above may be used. A deactivation state may be valid until signalled by the eNB to be in a different state. Sleep or discontinuous reception is where the UE is deactivated for a limited configured amount of time, after which the PCell is active again.

Some embodiments may be used where UE is configured with a PCell and a SCell in both DL and UL. In another embodiment, the UE is allocated PCell and SCell in DL, but only PCell in UL. In this case at PCell deactivation: the UE may switch UL PCell to the UL carrier linked to the DL SCell. In some cases this may cause a transmission gap which needs to be taken into account at the eNB scheduler. This may be avoided or mitigated by the eNB pre-configuring redundant PUCCH resources on a non configured cell/carrier (such resources may start to be used after the PCell has switched to new carrier).

In Rel-10 agreement, the PCell is used for RRC connection re-establishment. In some embodiments, compatibility may be maintained by requesting the eNB to re-activate the PCell before RRC connection re-establishment is performed.

The R bit of the Activation/Deactivation MAC Control Element introduced in Rel-10 for the activation/deactivation of SCells may also used to control the activation/de-activation of the PCell. The R bit is a bit “Reserved” for future use and some embodiments may be used to control the activation/deactivation of the PCell.

Some embodiments may have an advantage in that network operators can deploy CA to enable fast and seamless traffic steering strategies between carriers operating indifferent frequency bands while reducing the impact on UE power consumption.

Alternatively or additionally an advantage may be in case of inter-site CA in HetNet scenarios where aggregation of non-co-located carriers is possible using low-latency connection between nodes. In this case CA can be deployed to facilitate seamless handover and offloading from macro-layer to pico-layer (and vice-versa), while still providing power savings at the UE HetNet scenario is a heterogeneous network deployment with both wide area (macro eNB) and local area (micro/pico/home or femto eNB) access points. In some embodiments, one eNB may provide a PCell and another eNB may provide a SCell. For example a macro eNB may provide a PCell and the home eNB may provide a SCell. This is by way of example only and each of the eNBs may provide more than one cell. The two cells may be a macro cell and a pico cell, a macro cell and a femto cell, a pico cell and a femto cell, a pico cell and a pico cell, or a femto cell and a femto cell. In some embodiments, more than two eNBs may be providing the aggregated carrier. One cell may be provided more than one carrier.

In one embodiment the L1 feedback is provided by via the PUSCH on SCell and/or the PUCCH on the SCell. The eNB may either schedule resources for each A/N, CQI and SR on the SCell, or to book PUCCH resources on both the PCell and SCell

Embodiments may be used where the eNB needs to temporarily schedule data to/from the UE on the SCell.

In some embodiments as the PCell is de-activated, radio link monitoring of the SCell may need to take place instead of the UE periodically monitors the link quality on PCell.

In Rel-10 a SCell de-activation timer has been proposed. After having been inactive for a network-configured time period, an activated SCell is automatically de-activated with no need for explicit signalling from the eNB. In the current proposals, the PCell cannot be de-activated and does not have any associated de-activation timer.

However as discussed previously, some embodiments allow the PCell to be deactivated.

Some embodiments relate to the handling of SCell de-activation timer and optionally to a PCell de-activation timer.

In some embodiments, at least one serving cell in the configured set of serving cells should always be activated at any time in order to allow the eNB and UE to communicate. In some embodiments, when the de-activation timer of an SCell expires, if that SCell was the last activated SCell of the configured set of serving cells, the PCell is then automatically re-activated. This assumes that the PCell was deactivated when the SCell is to be deactivated.

In some embodiments, a SCell may offer both uplink and downlink to allow the UE and eNB to communicate. When the de-activation timer of a SCell expires, if that SCell was the last activated SCell offering both uplink and downlink in the configured set of serving cells, the PCell is then automatically re-activated.

In some embodiments, separate de-activation timers for the PCell and the SCell are provided. If the SCell de-activation timer expires and the UE is configured with more than one serving cell it is determined if that SCell is the only cell currently activated for the corresponding UE possibly offering both uplink and downlink. If so the PCell is automatically re-activated. If the PCell de-activation timer expires and the UE is configured with more than one serving cell, it is determined if the PCell is the only cell currently activated for the corresponding UE possibly offering both uplink and downlink. If so one of the configured SCells is automatically re-activated. The SCell may be selected using any suitable criteria such as a predefined priority list.

If the PCell de-activation timer expires and the UE has no SCell configured, the PCell may be prevented from running. Alternatively the PCell de-activation timer may not be run when the UE is not configured with any SCell.

In some embodiments, the PCell is reactivated upon the SCell deactivation timer expiring.

In some embodiments, “infinity” is the appropriate option for the PCell de-activation timer, and the PCell may therefore only bede-activated via explicit signalling by the eNB. This may be an option if a network wants to have full control when the PCell is deactivated.

In some embodiments, de-activation of the PCell is only permitted via explicit signalling (i.e. there is no PCell de-activation timer or PCell de-activation timer is set to “infinity”). In some embodiments, there may be some situations where the PCell may be deactivated via explicit signalling and other situations where the PCell may be deactivated by the expiry of the timer. In some embodiments, the PCell may only be deactivated on the expiry of a timer.

In some embodiments, the PCell is automatically re-activated if the SCell de-activation timer expires and the UE does not have any other SCell configured and activated. In some embodiments, whenever the de-activation timer of a SCell expires the PCell would always be reactivated. This is assuming the PCell is deactivated.

In some embodiments, the PCell is automatically re-activated if the UE receives a de-activation message and the corresponding CC is the only one still active for the UE. If the PCell is the only CC which is active, the UE may ignore the de-activation message.

Some embodiment may provide compatibility with the Rel-10 mode of operation if the SCell de-activation timer expires. Some embodiments provide continued operation even if the UE receives a de-activation message for all the configured CCs which may happen in case of signalling errors between the eNB and UE.

FIG. 4 shows a method. It should be appreciated that in some embodiments, all the method steps of FIG. 4 may be performed by a user equipment. Alternatively or additionally the method maybe performed by an eNB. In some embodiments, part of the method may be performed by the eNB and part of the method may be performed by the UE.

For example the method may be performed by one or more processor with one or more memory. The embodiment may at least partially be performed by the execution of one or more computer instructions or a computer program.

In step S1, a determination is made as to whether or not a carrier deactivation timer has expired. If no timer has expired, the method loops back to step S1. If the timer has expired, the next step is step S2.

In step S2, a determination is made as to whether this is the last carrier to be active. If this is not the last carrier to be active, then the method loops back to step S1. If this is the last carrier to be active then the next step is step S3.

In step S3, a determination is made as to whether the carrier is a PCell or a SCell. If the carrier is a PCell, the next step is S5 whilst if the carrier is a SCell, the next step is step S4.

In step S4, the PCell is reactivated and the SCell is deactivated.

In step S5, the PCell is prevented from being deactivated.

It should be appreciated that at least some of the steps may be performed in the UE. It should be appreciated that one or more of steps S1 to S3 may be performed as a single step.

Reference is made to FIG. 5 which shows a UE which may perform the method of FIGS. 4 and/or 6, for example. The UE comprises an antenna 60 which is configured to transmit and/or receive signals. In the embodiment shown there are a first RF branch 50 and a second RF branch. In one embodiment, the first and second RF branches are used for different P or SCells. It should be noted that in some embodiments there may be more than two RF branches. In other embodiments, a single RF branch may be used to support one or more of the different cells.

One RF branch may be for the PCell and the other RF branch may be for a SCell.

A branch selection block 54 is shown. This will direct signals to and/or from the respective RF branch.

The branch selection branch is coupled to a resource controller 54. The resource controller 56 is coupled to a timer 58 which is configured to provide the respective countdown timer for the PCell or SCell as required. The resource controller is configured, in some embodiments to perform the method of FIG. 4.

One or more of the branch selection block, resource controller and timer may be implemented by one or more processors in association with one or more memories.

It should be appreciated that in some embodiments, a PCell or SCell is deactivated when a timer expires. In other embodiments, different mechanisms may be used to deactivate the PCell or SCell.

Currently when CA is configured in Release 10, a UE may be scheduled over a plurality of serving cells simultaneously. Cross-carrier scheduling with the Carrier Indicator Field (CIF) allows the PDCCH of a serving cell to schedule resources on another serving cell but with the following rules:
cross-carrier scheduling does not apply to PCell i.e. PCell is always scheduled via its PDCCH;
when the PDCCH of an SCell is configured, cross-carrier scheduling does not apply to this SCell i.e. it is always scheduled via its PDCCH; and
when the PDCCH of a SCell is not configured, cross-carrier scheduling applies and this SCell is always scheduled via the PDCCH of one other serving cell.

A linking between UL and DL allows identifying the serving cell for which the grant applies when the CIF is not present. The following apply:
DL assignment received in PCell corresponds to downlink transmission in PCell;
UL grant received in PCell corresponds to uplink transmission in PCell;
DL assignment received on in SCelln corresponds to downlink transmission on in SCelln; and
UL grant received in SCelln corresponds to uplink transmission in SCelln. If SCelln is not configured for uplink usage by the UE, the grant is ignored by the UE.

In some scenarios with the current proposals, there might be a situation/configuration such that more than one SCell is configured/activated, and the PCell might also be scheduling one or more carriers using a concept called cross-carrier scheduling. In case the PCell is de-activated, the cross-carrier possibility is effectively disabled.

Some embodiments automatically adjust cross-carrier scheduling properties of each SCell upon PCell deactivation in order to ensure that no SCell is left without any possibility of being scheduled.

For instance, a temporary “inheritance” of PCell cross-carrier scheduling properties may be provided whenever a PCell is de-activated. One SCell becomes the main source of scheduling. That SCell may become a virtual or temporary PCell for cross carrier scheduling. This one SCell could either be the SCell with the lowest index. An index may be assigned at CC configuration and this may determine the priority between the configured SCells. RRC signailing is used for CC configuration, so if different priority than using index has to be used that could be communicated during CC configuration.

In another embodiment, the CrossCarrierSchedulingConfig in RRC [see 3GPP TS specification 36.331] may be changed such that two schedulingCellId-r10 are given: one that applies when PCell is active and another one that applies when PCell is deactivated.

To illustrate some embodiments, with a simple example of a network configuration with 3 carriers configured for a given UE will be considered such as shown in FIG. 1. Reference is also made to FIG. 7 which shows a method. The PCell is assigned to carrier F1, while carriers F2 and F3 are configured and activated as SCells. Carrier F2 is being scheduled with low control channel overhead (either as a future extension carrier without a control channel or as a PDCCH-less carrier) using a concept called cross-carrier scheduling from the PCell (scheduling grants for both carrier F1 and F2 are handled from the PCell on carrier A).

Due to traffic steering considerations, it is seen more effective from a network perspective that the current PCell is temporarily put into a sleep mode or deactivated, in step A1. The SCell operating in carrier F3 becomes the main source of scheduling in step A2. This means that the SCell on carrier F3 will start hosting the cross-carrier scheduling instead of the PCell, and it is still possible to schedule carrier F2 while the regular PCell is not in use towards the given UE, as shown in step A3. These embodiments may performed by the eNB and/or the UE.

Some embodiments may have the advantage that network operators can deploy CA to enable fast and seamless traffic steering strategies between carriers operating indifferent frequency bands while reducing the impact on UE power consumption. With some embodiments, the disadvantages of temporarily disabling the PCell will be reduced.

The definition of primary and secondary cells may be the similar to Rel-10. However in some embodiments, one or more functionalities in Rel-10 which use the PCell (for example PUCCH transmission, radio link monitoring, etc.) may be temporarily passed to the SCell. In some embodiments if a cell is deactivated, it is not available for scheduling. That cell may be available to a different UE

In general a primary cell or carrier may be considered to be one where control information is at least one of provided to or from a UE. When the primary cell or carrier is activated, this control information is not provided via the secondary carrier or secondary cell. This control information may be required for use of the second carrier or cell. When the primary cell or carrier is deactivated, any one or more of the embodiments may be used

Embodiments may be used where there is carrier aggregation in scenarios other than the LTE situations described above.

Embodiments may be used with other primary and/or secondary cells, other than the PCells and SCells described above.

It should be appreciated that the embodiments may be implemented by one or more computer programs running on one or more processors, hardware, firmware, dedicated circuits or any combinations of two or more of the above. Some embodiments may make use of one or more memories. For example the computer programs may comprise computer executable instructions which may be stored in one or more memories. When run, the computer program(s) may use data which is stored in one or more memories.

It is noted that whilst embodiments have been described in relation to certain architectures, similar principles can be applied to other communication systems where carrier aggregation is provided. For example, this may be the case in application where no fixed access nodes are provided but a communication system is provided by means of a plurality of user equipment, for example in adhoc networks. Also, the above principles can also be used in networks where relay nodes are employed for relaying transmissions. Therefore, although certain embodiments were described above by way of example with reference to certain exemplifying architectures for wireless networks, technologies and standards, embodiments may be applied to any other suitable forms of communication systems than those illustrated and described herein. It is also noted that different combinations of different embodiments are possible. It is also noted herein that while the above describes exemplifying embodiments of the invention, there are several variations and modifications which may be made to the disclosed solution without departing from the spirit and scope of the present invention.

1-31. (canceled)

32. A method comprising:
causing a primary cell for a user equipment to be deactivated, said user equipment having at least one active secondary cell.

33. A method as claimed in claim 32, performing radio link monitoring of said deactivated primary cell less frequently than when the primary cell is activated.

34. A method as claimed in claim 32, comprising causing feedback information to be conveyed via said secondary cell.

35. A method as claimed in claim 34, wherein said feedback in formation comprises at least one of channel quality information, scheduling request and hybrid automatic repeat request acknowledgement/non acknowledgement.

36. A method as claimed in claim 34, comprising causing information to be provided to a base station indicating that data for transmission is in a buffer of said user equipment.

37. A method as claimed in claim 32 comprising using one of said active secondary cells to schedule traffic on at least one other active secondary cell when said primary cell is deactivated.

38. A method as claimed in claim 32, comprising determining that the primary cell is to be deactivated and only deactivating said primary cell if at least one secondary cell is activated.

39. A method as claimed in claim 32, comprising determining that a primary cell is to be deactivated and activating a secondary cell if said primary cell is the only active cell for a user equipment.

40. A method as claimed in claim 32, comprising determining if a secondary cell is to be deactivated and reactivating said primary cell.

41. A method as claimed in claim 40, comprising reactivating said primary cell if the secondary cell to be deactivated is the only active cell.

42. A method as claimed in any of claim 32, comprising causing a user equipment to be configured with an uplink and a downlink for said primary cell and only a downlink for at least one active secondary cell.

43. A method as claimed in claim 42, wherein responsive to deactivation of said primary cell, causing an uplink to be configured for said at least one active secondary cell.

44. A computer program comprising at least one computer executable instruction which when run on a processor is configured to cause the method of claim 32 to be performed.

45. Apparatus comprising at least one processor and at least one memory including computer program code, the at least one memory and computer program code configured, with the at least one processor, to cause the apparatus to:
cause a primary cell for a user equipment to be deactivated, said user equipment having at least one active secondary cell.

46. Apparatus as claimed in claim 45, wherein the at least one memory and computer program code is configured, with the at least one processor, to cause the apparatus to use one of said active secondary cells to schedule traffic on at least one other active secondary cell when said primary cell is deactivated.

47. Apparatus as claimed in claim 45, wherein the at least one memory and computer program code is configured, with the at least one processor, to cause the apparatus to, determine that the primary cell is to be deactivated and only deactivating said primary cell if at least one secondary cell is activated.

48. Apparatus as claimed in claim 45, wherein the at least one memory and computer program code is configured, with the at least one processor, to cause the apparatus to, determine that a primary cell is to be deactivated and activate a secondary cell if said primary cell is the only active cell for a user equipment.

49. Apparatus as claimed in claim 45, wherein the at least one memory and computer program code is configured, with the at least one processor, to cause the apparatus to determine if a secondary cell is to be deactivated and if so, reactivating said primary cell.

50. Apparatus as claimed in claim 49, wherein the at least one memory and computer program code is configured, with the at least one processor, to cause the apparatus to reactivate said primary cell if the secondary cell to be deactivated is the only active cell.

51. User equipment or a base station comprising apparatus as claimed in claim 45.
